(19) United States
(12) Patent Application Publication
(10) Pub. No.: US 2022/0128815 A1
(43) Pub. Date: Apr. 28, 2022

(54) GLASSES-TYPE DISPLAY DEVICE FOR REALIZING A HIGH VIEWING ANGLE

(71) Applicant: Sung Min LEE, Gimpo-si (KR)

(72) Inventor: Sung Min LEE, Gimpo-si (KR)

(21) Appl. No.: 17/093,900

(22) Filed: Nov. 10, 2020

(30) Foreign Application Priority Data
Oct. 27, 2020 (KR) 10-2020-0140591

(51) Int. Cl. G02B 27/01; G02B 5/30; G02C 5/14; G02C 11/00; G02B 27/28; G02C 9/04; G06T 7/55

(52) U.S. Cl. CPC G02B 27/0172; G02B 5/3033; G02C 5/146; G02C 11/10; G02B 2027/014; G02C 9/04; G06T 7/55; G02B 2027/0138; G02B 2027/0178; G02B 27/288

(57) ABSTRACT

In a glasses-type display device according to an example of the present disclosure to solve the technical problems described above, there is provided a glasses-type display device including: a glasses frame including a lens fixing frame that fixes a lens disposed to correspond to the eye of a user, and a temple frame that extends from the lens fixing frame to serve as a temple; a dual camera module installed on the lens fixing frame and disposed to face a same viewpoint as that of the user; a display module installed at a lower end of the lens fixing frame to output an image to enter the eye of the user; and a glasses lens installed on the lens fixing frame to allow external light generated from a front to enter the eye of the user.

### CROSS-REFERENCE TO RELATED APPLICATION

This application claims priority to and the benefit of Korean Patent Application No. 10-2020-0140591 filed in the Korean Intellectual Property Office on Oct. 27, 2020, the entire contents of which are incorporated herein by reference.

### TECHNICAL FIELD

The present disclosure relates to a glasses-type display device having a structure similar to that of glasses and a high viewing angle.

### BACKGROUND ART

A growth of a market of mixed reality (MR) display glasses is a key field of a fourth industrial revolution that is emerging recently. A scale of a market considering a situation of next-generation technology that combines advantages of a virtual reality (VR) and an augmented reality (AR) is currently insignificant, but is expected to expand rapidly by 69.7% in the future.

In such a situation, light display devices having various types of glasses are being developed, away from a conventional head mount display (HMD) device that covers the entire head of a user.

However, unlike the conventional HMD device, the glasses-type display device is unreasonable to provide a high wide viewing angle to the user as a limited lens size of the glasses and the display device are combined.

In addition, if the user is using the glasses, there is a limit to the use of the glasses-type display device.

### SUMMARY

### Technical Solution

In order to solve the problems described above, an object of the present disclosure is to implement a display device having a structure of glasses that provides a user with a mixed reality having a high wide viewing angle.

In addition, another object of the present disclosure is to provide a structure of a glasses-type display device that can also be used by an existing glasses wearer.

In a glasses-type display device according to an example of the present disclosure to solve the technical problems described above, there is provided a glasses-type display device including: a glasses frame including a lens fixing frame that fixes a lens disposed to correspond to the eye of a user, and a temple frame that extends from the lens fixing frame to serve as a temple; a dual camera module installed on the lens fixing frame and disposed to face a same viewpoint as that of the user; a display module installed at a lower end of the lens fixing frame to output an image to enter the eye of the user; and a glasses lens installed on the lens fixing frame to allow external light generated from a front to enter the eye of the user. The display module analyzes the front image acquired through the dual camera module to acquire a depth value for an object entering from the front, and outputs the image to the eye of the user by referring to the depth value, thereby allowing the user to view an augmented reality image through the front image transmitted through the lens and the image output through the display module.

In addition, the display module may include an image output portion disposed to face the eye of the user and outputting an image; a mirror portion disposed to face the image output portion to reflect the output image toward an upper end of the lens fixing frame; a polarization filter portion installed on the lens fixing frame and disposed at an upper end of the image output portion and the mirror portion to polarize the light reflected through the mirror portion; and a beam splitter portion installed at the upper end of the lens fixing frame and reflecting the image passing through the polarization filter portion to be directed to the eye of the user, and selectively transmitting light generated from the front of an outside of the glasses-type display device to the eye of the user.

In addition, the polarization filter portion may block light, which is generated in the outside and directed toward the mirror portion or the image output portion and passing through the polarization filter portion, and then be reflected back, to prevent the light from entering the eye of the user through the polarization filter portion.

In addition, the polarization filter portion may be configured of a circular polarization film.

In addition, the image output portion and the mirror portion may be disposed to face each other and form an acute angle, the beam splitter portion may be disposed to face the mirror portion to be disposed at an angle to reflect the image reflected on the mirror portion to the eye of the user, and the polarization filter portion may be disposed between the mirror portion and the beam splitter portion.

In addition, the lens fixing frame and the temple frame may be each provided with a fixing portion capable of being coupled to each other to couple or separate the lens fixing frame and the temple frame.

In addition, a rear surface portion of the lens fixing frame may have a shape corresponding to that of a front surface portion of the glasses based on a viewpoint viewed by the user, and the glasses may be in close contact with the rear surface portion of the lens fixing frame and sandwiched between a pair of the fixing portions, and when the fixing portions are provided on the glasses, the temple frame may be coupled or separated.

In addition, in one region of the temple frame, an earring portion having a structure that is caught by the ear of the user may be provided, the earring portion may be provided with a wireless power receiver for receiving wireless power from the outside, and the glasses-type display device may further include a wireless power transmitter that provides power to the wireless power receiver, and the wireless power transmitter may be configured to be physically independent from the glasses frame and may be formed of a hole having a size and a shape capable of being inserted into the earring portion, thereby beings inserted, through the hole, into the earring portion provided with the wireless power receiver to receive external power and transmit the external power to the wireless power receiver.

In addition, any one of the lens fixing frame and the temple frame may be further provided with a gyro sensor, a speaker, and a microphone.

In addition, the glasses lens may be configured to have a preset color to control external light entering the glasses-type display device.

### Advantageous Effects

According to an example of the present disclosure, it is possible to implement a glasses-type display device that provides a user with a mixed reality having a high wide viewing angle.

In addition, a structure of a glasses-type display device is provided, which can be used by an existing glasses wearer while wearing the glasses.

### DESCRIPTION OF DRAWINGS

FIG. 1 is a perspective view illustrating an appearance of a glasses-type display device according to an example of the present disclosure.

FIG. 2 is a view illustrating a configuration of a display module 100 according to an example of the present disclosure.

FIG. 3A is a perspective view illustrating a configuration of a glasses frame according to an example of the present disclosure.

FIG. 3B is a perspective view illustrating a configuration of a glasses frame according to an example of the present disclosure.

FIG. 4A is a view illustrating a structure of a temple frame and a power transmitter according to an example of the present disclosure.

FIG. 4B is a view illustrating a structure of a temple frame and a power transmitter according to an example of the present disclosure.

FIG. 4C is a view illustrating a structure of a temple frame and a power transmitter according to an example of the present disclosure.

FIG. 5A is a perspective view illustrating a coupling of a glasses-type display device and glasses according to an example of the present disclosure.

FIG. 5B is a perspective view illustrating a coupling of a glasses-type display device and glasses according to an example of the present disclosure.

FIG. 6 is a view illustrating an additional configuration included in the temple frame according to an example of the present disclosure.

### DETAILED DESCRIPTION OF EMBODIMENTS

Hereinafter, examples of the present disclosure will be described in detail with reference to the accompanying drawings so that those of ordinary skill in the art can easily implement the present disclosure. However, the present disclosure may be implemented in various different forms, and is not limited to the examples described herein. In the drawings, portions irrelevant to the description are omitted in order to clearly describe the present disclosure, and similar reference numerals are assigned to similar portions throughout the specification.

Throughout the specification, when a portion is said to be “connected” to another portion, this includes not only “directly connected” but also “electrically connected” with another element in the middle. In addition, when a portion “includes” a certain component, it means that other components may be further included and not excluding other components, unless specifically stated to the contrary. It is to be understood that it does not preclude the presence or addition of one or more other features, any number, a step, an operation, a configuration element, a component, or a combination thereof.

The following examples are detailed descriptions for aiding understanding of the present disclosure, and do not limit the scope of the present disclosure. Therefore, the disclosure of the same scope performing the same function as that of the present disclosure will also belong to the scope of the present disclosure.

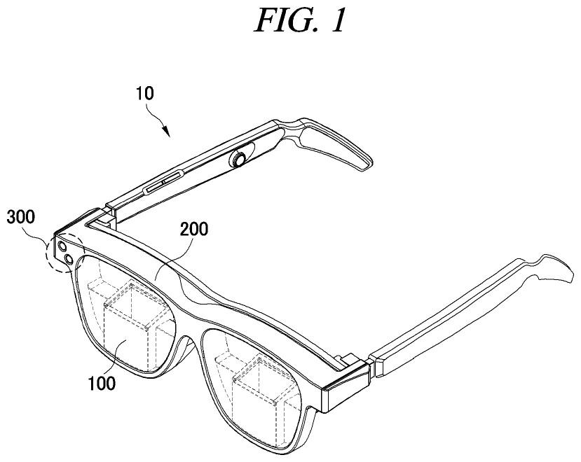

FIG. 1 is a perspective view illustrating an appearance of a glasses-type display device according to an example of the present disclosure.

Referring to FIG. 1, according to an example of the present disclosure, a glasses-type display device 10 may include a display module 100, a glasses frame 200, and a dual camera module 300.

According to an example of the present disclosure, when a user wears the glasses-type display device 10, the dual camera module 300 photographs a front that the user is looking at and recognizes a depth value for a landscape or an object, the display module 100 outputs an AR or VR image based on the depth value and the recognized position, and then the image enters the eye of the user. As a further example, the display module 100 may be wirelessly connected to a user terminal (for example, a smartphone or a tablet PC) to receive a content image of the user terminal from the user terminal and display the AR image or the VR image.

According to an example of the present disclosure, the display module 100 is installed at a lower end of the lens fixing frame of the glasses frame 200 and outputs the image to enter the eye of the user.

As an alternative example, the display module 100 may be provided at a lower portion of the glasses frame 200 based on a position corresponding to the eyeball of the user, thereby expanding the view field of the user looking at the front.

According to an example of the present disclosure, the frame 200 may include a lens fixing frame that serves to fix a lens disposed to correspond to the eye of the user, and a temple frame that extends from the lens fixing frame to serve as a temple frame.

In this case, if the glasses frame 200 can be worn like glasses to allow the display module 100 correspond to the eye of the user, it may be implemented in various forms. That is, as long as a characteristic shape similar to that of the conventional glasses is satisfied, detailed designs can be adopted in various ways, and thus the scope of the present disclosure is not limited.

In addition, although a separate reference number is not designated on the drawing, a glasses lens may be included which is installed on the lens fixing frame of the glasses frame 200 and allows external light generated from the front to enter the eye of the user.

In this case, the glasses lens may be provided in the glasses-type display device 10 in a form corresponding to that of the conventional glasses lens, and may be provided in various colors.

For example, it may be provided with a transparent lens without a color or a lens having a black color such as sunglasses, and may cover the display module 100 installed in the glasses-type display device 10.

As a further example, the glasses lens may have a blackout function so that the display module 100 provides only an image photographed through the dual camera module 300 to the eye of the user.

According to an example of the present disclosure, the dual camera module 300 is installed on the lens fixing frame of the glasses frame 200 and is disposed to face the same viewpoint as that of the user.

In this case, the display module 100 analyzes the image form the front obtained through the dual camera module 300 and acquires a depth value of an object entering from the front.

In addition, the display module 100 outputs the image to the eye of the user by referring to the acquired depth value, so that the user can be derived to see the augmented reality image through the image from the front, which is transmitted through the glasses lens, and the image output through the display module 100.

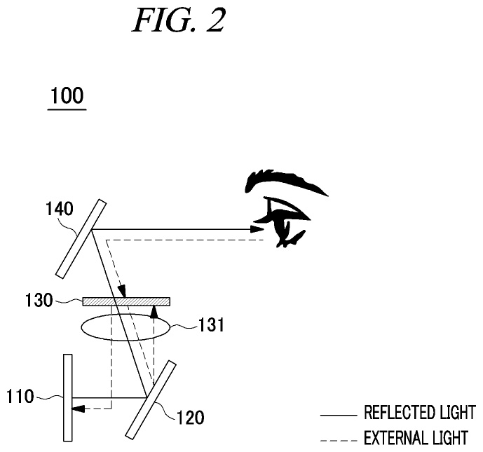

FIG. 2 is a view illustrating a configuration of the display module 100 according to an example of the present disclosure.

Referring to FIG. 2, the display module 100 according to an example of the present disclosure includes an image output portion 110, a mirror portion 120, a polarization filter portion 130, and a beam splitter portion 140. In this case, an additional lens 131 may be further provided in the polarization filter portion 130.

According to an example of the present disclosure, the image output portion 110 is disposed in a direction facing the eye of the user, and outputs the image.

For example, the image photographed through the dual camera module 300 is analyzed to output the image of the AR or the VR that overlaps the landscape transmitted through the glasses lens.

According to an example of the present disclosure, the mirror portion 120 is disposed to face the image output portion 110 to reflect the output image toward an upper end of the lens fixing frame.

As an optional example, the image output portion 110 and the mirror portion 120 may be disposed to face each other to form an acute angle. That is, the image output portion 110 is not disposed in parallel with the eye of the user but vertically disposed. This solves problems of securing a space in which the image output portion 110 is provided and blocking the light reflected through the mirror portion 120 again by the image output portion 110.

According to an example of the present disclosure, the polarization filter portion 130 is installed on the lens fixing frame, is disposed at the upper end of the image output portion 110 and the mirror portion 120, and polarizes the light reflected through the mirror portion 120.

In this case, the polarization filter portion 130 blocks the light, which is generated from the outside and is directed to the mirror portion 120 or the image output portion 110, so that the light does not pass through the polarization filter portion 130 and then reflect again to enter the eye of the user through the polarization filter portion 130.

For example, in a case where the external light entering the display module 100 through the glasses lens is directed toward the mirror portion 120 through the polarization filter portion 130, the external light is reflected again and is directed toward the polarization filter portion 130. If the polarization filter portion 130 does not block the external light, since the reflected external light enters the eye of the user again, a problem occurs in that the user recognizes the image of the outside as two images, or the image generated by the output portion 110 is damaged. Accordingly, the polarization filter portion 130 may include a circular polarization film.

In this case, the polarization filter portion 130 is provided with a separate additional lens 131 together to reverse the image reflected through the mirror portion 120 to help the user to recognize a right direction.

According to an example of the present disclosure, the beam splitter portion 140 is installed at the upper end of the lens fixing frame and reflects the image passing through the polarization filter portion 130 so that the image is directed toward the eye of the user, but the light generated from the front of the outside of the glasses-type display device 10 is selectively transmitted to the eye of the user.

In this case, the beam splitter portion 140 is disposed to face the mirror portion 120 and is disposed at an angle to reflect the image reflected by the mirror portion 120 to the eye of the user. Accordingly, the polarization filter portion 130 is disposed between the mirror portion 120 and the beam splitter portion 140. In addition, the light generated from the front of the glasses-type display device 10 may be selectively transmitted.

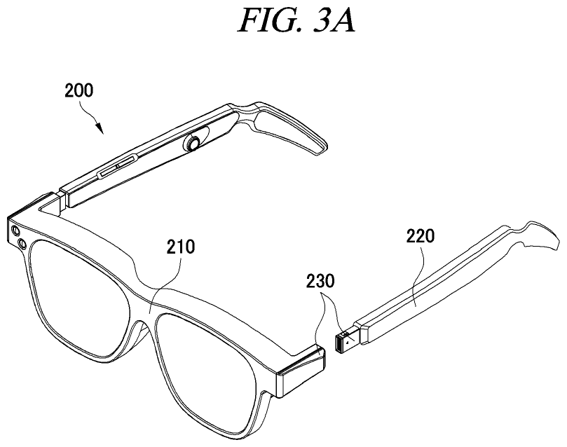

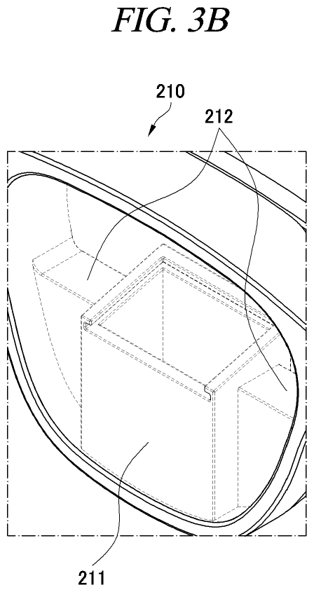

FIGS. 3A and 3B are perspective views illustrating the configuration of a glasses frame according to an example of the present disclosure.

First, referring to FIG. 3A, according to an example of the present disclosure, the glasses frame 200 includes a lens fixing frame 210 and a temple frame 220.

According to an example of the present disclosure, as described above, the lens fixing frame 210 serves to fix the lens and the display module 100 disposed to correspond to the eye of the user in the glasses-type display device 10.

In addition, according to an example of the present disclosure, the temple frame 220 is provided to fix the lens fixing frame 210 to the face of the user, and as described above, is extended from the lens fixing frame 210 to perform a similar role to the conventional temple. In this case, a structure or a function of the temple frame 220 will be further described through each of the drawings to be described later.

As an optional example, the lens fixing frame 210 and the temple frame 220 may be each provided with a fixing portion 230 capable of coupling to each other.

Therefore, the lens fixing frame 210 and the temple frame 220 may be coupled or separated through the fixing portions 230.

In addition, the fixing portion 230 may include a function of transmitting and receiving data, and supplying power between the lens fixing frame 210 and the temple frame 220.

In this case, as an optional example, the fixing portion 230 may be coupled through magnetism or through a structure that is fitted to each other, or the like. That is, the structure of the fixing portion 230 can be implemented in various ways, so that the scope of the present disclosure is not limited.

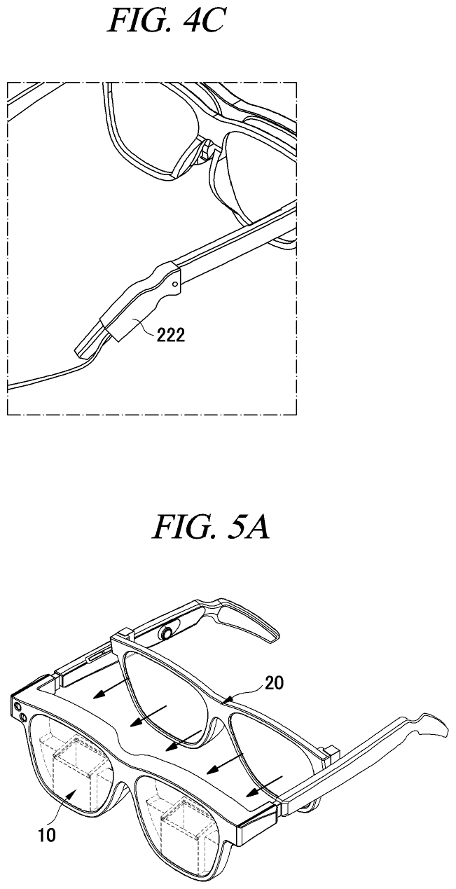

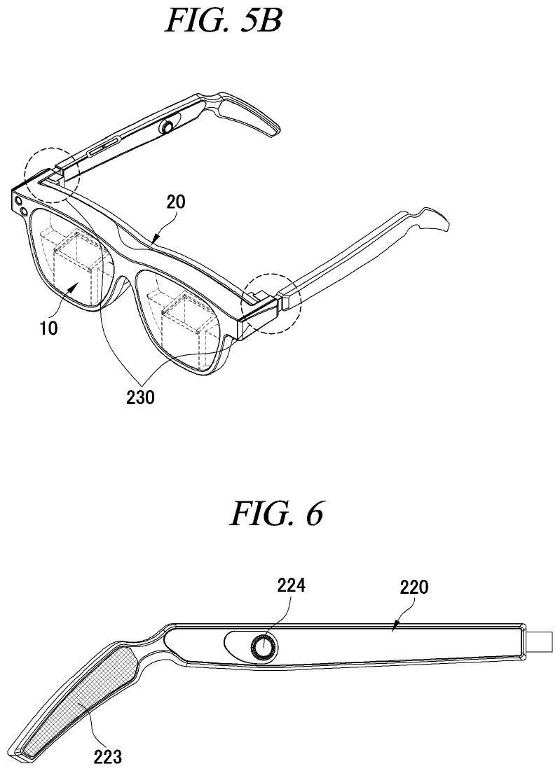

In this case, referring to FIGS. 5A and 5B, a function for the user who wears glasses 20 may be further included.

Specifically, the rear surface portion of the lens fixing frame 210 of the glasses-type display device 10 has a shape corresponding to that of the front surface portion of the glasses 20 based on the viewpoint viewed by the user. The glasses 20 are in close contact with the rear surface portion of the lens fixing frame 210, are sandwiched between a pair of fixing portions 230, and thereby the user can use the glasses-type display device 10.

That is, as illustrated in FIG. 5A, the glasses 20 are in close contact with an inside of the glasses-type display device 10 to be coupled as illustrated in FIG. 5B.

In this case, as an optional example, in a case where the fixing portions 230 are also provided in the glasses 20, the temple frame 220 may be coupled to the glasses 20.

As a further example, a supporter may be provided in a region on the rear surface portion of the lens fixing frame 210 so that the lens fixing frame 210 may be fixed to the eye rim of the user.

The supporter is mounted on the nose of the user, and in consideration of a weight of the glasses-type display device 10, an elastic material is formed in a region that directly comes into contact with the face of the user to prevent the nose from being pressed.

Next, referring to FIG. 3B, a structure of the lens fixing frame 210 in which the display module 100 is disposed is illustrated.

In this case, the lens fixing frame 210 includes a display mounting frame 211 and intermediate frames 212.

The display mounting frame 211 is provided with the display module 100, a predetermined space is provided, and the display module 100 is inserted into the space.

In this case, as illustrated in the drawings, the display mounting frame 211 is located at a lower end of the lens fixing frame 210 based on a center thereof, and does not cover the eye of the user as much as possible, so that the user can have a wide viewing angle. That is, the display mounting frame 211 has a height of less than half the height of the lens fixing frame 210, and it is possible to provide a wider viewing angle to the user as a size thereof decreases based on the development of technology.

The intermediate frame 212 fixes the display mounting frame 211 to the lens fixing frame 210, and various wires connected to the display module 100 may be embedded.

In this case, the intermediate frame 212 is implemented to have a thickness less than that of the display mounting frame 211 in order to reduce a weight as much as possible, and like the display mounting frame 211, the intermediate frame 212 is implemented to have a height of less than half the height of the lens fixing frame 210 so as not to block the view field of the user.

In an optional example, a preset color is formed on the glasses lens or a blackout film is implemented, so that the display mounting frame 211 and the intermediate frame 212 may not be seen from the outside.

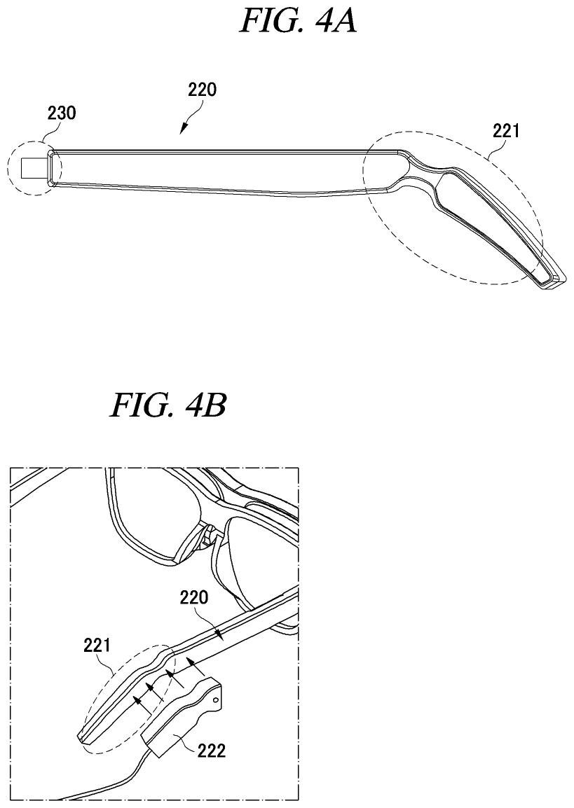

FIGS. 4A to 4C are views illustrating a structure of the temple frame 220 and a power transmitter according to an example of the present disclosure.

First, referring to FIG. 4A, an earring portion 221 having a structure that is caught on the ear of the user is provided in one region of the temple frame 220.

For example, the earring portion 221 has a shape of a curved surface that can be worn on the ear similar to the leg of the conventional glasses 20, but has a recess structure in one region.

Next, referring to FIG. 4B, the earring portion 221 may be provided with a wireless power receiver for receiving wireless power from the outside.

In addition, the glasses-type display device 10 may further include a wireless power transmitter 222 for providing power to the wireless power receiver.

In this case, the wireless power transmitter 222 is configured to be physically independent from the glasses frame 200, and a hole having a size and a shape capable of being inserted into the earring portion 221 is formed.

Accordingly, after being inserted into the recess portion of the earring portion 221 provided with the wireless power receiver through the hole of the wireless power transmitter 222 as illustrated in FIG. 4C, external power is supplied and transmitted to the wireless power receiver.

FIG. 6 is a view illustrating an additional configuration included in the temple frame according to an example of the present disclosure.

Although only the temple frame 220 is illustrated in FIG. 6, a gyro sensor, a speaker 223, a microphone 224, and the like may be further provided in either of the lens fixing frame and the temple frame.

Through the gyro sensor, each time the user turns his/her head, the movement is recognized, and the image output portion 110 generates a mixed reality image suitable for the gaze of the user. In addition, a button for adjusting a volume or sensitivity of the speaker 223 and the microphone 224 may be provided.

In addition, a content may be provided to communicate between the speaker 223 and the microphone 224.

As another additional example, a global positioning system (GPS) and a communication module are further provided, so that various data can be received from an external server based on the location of the user, and a mixed reality content can be provided based on the received data.

For example, when the user enters a specific area through GPS, a description of a game, an event, or an ornament in that area can be downloaded from an external server and displayed. In this case, even if a separate internal storage device is not included, the desired glasses-type display device 10 may receive and provide it to the user.

The above description of the present disclosure is for illustrative purposes only, and those of ordinary skill in the art to which the present disclosure pertains will be able to understand that other specific forms can be easily modified without changing the technical spirit or essential features of the present disclosure. Therefore, it should be understood that the examples described above are illustrative and non-limiting in all respects. For example, each configuration element described as a single type may be implemented in a distributed manner, and similarly, configuration elements described as being distributed may also be implemented in a combined form.

The scope of the present disclosure is indicated by the claims to be described later rather than the detailed description, and all changes or modified forms derived from the meaning and scope of the claims and their equivalent concepts should be interpreted as being included in the scope of the present disclosure.

Description of Symbols

| | |
|---|---|
| 10: glasses-type display device | 20: glasses |
| 100: display module | 200: glasses frame |
| 300: dual camera module | |

What is claimed is:

1. A glasses-type display device comprising:
a glasses frame including a lens fixing frame that fixes a lens disposed to correspond to an eye of a user, and a temple frame that extends from the lens fixing frame to serve as a temple;
a dual camera module installed on the lens fixing frame and disposed to face a same viewpoint as that of the user;
a display module installed at a lower end of the lens fixing frame to output an image to enter the eye of the user; and
a glasses lens installed on the lens fixing frame to allow external light generated from a front to enter the eye of the user,
wherein the display module analyzes a front image acquired through the dual camera module to acquire a depth value for an object entering from the front, and outputs the image to the eye of the user by referring to the depth value, thereby allowing the user to view an augmented reality image through the front image transmitted through the lens and the image output through the display module.

2. The glasses-type display device according to claim 1,
wherein the display module includes:
an image output portion disposed to face the eye of the user and outputting an image;
a mirror portion disposed to face the image output portion to reflect the output image toward an upper end of the lens fixing frame;
a polarization filter portion installed on the lens fixing frame and disposed at an upper end of the image output portion and the mirror portion to polarize the light reflected through the mirror portion; and
a beam splitter portion installed at the upper end of the lens fixing frame and reflecting the image passing through the polarization filter portion to be directed to the eye of the user, and selectively transmitting light generated from the front of an outside of the glasses-type display device to the eye of the user.

3. The glasses-type display device according to claim 2,
wherein the polarization filter portion blocks light, which is generated in the outside and directed toward the mirror portion or the image output portion and passing through the polarization filter portion, and then be reflected back, to prevent the light from entering the eye of the user through the polarization filter portion.

4. The glasses-type display device according to claim 2,
wherein the polarization filter portion is configured of a circular polarization film.

5. The glasses-type display device according to claim 2,
wherein the image output portion and the mirror portion are disposed to face each other and form an acute angle,
wherein the beam splitter portion is disposed to face the mirror portion to be disposed at an angle to reflect the image reflected on the mirror portion to the eye of the user, and
wherein the polarization filter portion is disposed between the mirror portion and the beam splitter portion.

6. The glasses-type display device according to claim 1,
wherein the lens fixing frame and the temple frame are each provided with a fixing portion capable of being coupled to each other to couple or separate the lens fixing frame and the temple frame.

7. The glasses-type display device according to claim 6,
wherein a rear surface portion of the lens fixing frame has a shape corresponding to that of a front surface portion of the glasses based on a viewpoint viewed by the user, and the glasses are in close contact with the rear surface portion of the lens fixing frame and sandwiched between a pair of the fixing portions, and
wherein when the fixing portions are provided on the glasses, the temple frame is coupled or separated.

8. The glasses-type display device according to claim 1,
wherein in one region of the temple frame, an earring portion having a structure that is caught by an ear of the user is provided,
wherein the earring portion is provided with a wireless power receiver for receiving wireless power from the outside, and the glasses-type display device further includes a wireless power transmitter that provides power to the wireless power receiver, and
wherein the wireless power transmitter is configured to be physically independent from the glasses frame and may be formed of a hole having a size and a shape capable of being inserted into the earring portion, thereby beings inserted, through the hole, into the earring portion provided with the wireless power receiver to receive external power and transmit the external power to the wireless power receiver.

9. The glasses-type display device according to claim 1,
wherein any one of the lens fixing frame and the temple frame is further provided with a gyro sensor, a speaker, and a microphone.

10. The glasses-type display device according to claim 1,
wherein the glasses lens is configured to have a preset color to control external light entering the glasses-type display device.
